(19) United States
(12) Patent Application Publication
(10) Pub. No.: US 2011/0122299 A1
(43) Pub. Date: May 26, 2011

(54) IMAGE PROCESSING APPARATUS, IMAGE PROCESSING METHOD, AND CAMERA MODULE

(75) Inventor: Yukiyasu TATSUZAWA, Kanagawa (JP)

(73) Assignee: KABUSHIKI KAISHA TOSHIBA, Tokyo (JP)

(21) Appl. No.: 12/869,151

(22) Filed: Aug. 26, 2010

(30) Foreign Application Priority Data
Nov. 26, 2009 (JP) 2009-268571

(51) Int. Cl. H04N 9/64

(52) U.S. Cl. 348/246; 348/E09.042

(57) ABSTRACT

According to the embodiments, an image processing apparatus includes a weight coefficient calculating unit, a defect-correction-coefficient switching unit, and a convolution operation unit. The weight coefficient calculating unit calculates a weight coefficient for scaling processing. The defect-correction-coefficient switching unit performs switching of the weight coefficient for defect correction for a defect correction target pixel in which a defect is detected.

### CROSS-REFERENCE TO RELATED APPLICATIONS

This application is based upon and claims the benefit of priority from the prior Japanese Patent Application No. 2009-268571, filed on Nov. 26, 2009; the entire contents of all of which are incorporated herein by reference.

### FIELD

Embodiments described herein relate generally to an image processing apparatus, an image processing method, and a camera module.

### BACKGROUND

Recently, increase in the number of pixels of a camera module such as a camera mounted on a cell phone and a digital camera has progressed. Moreover, miniaturization of pixels is also required due to increase in pixel size. Under such a condition, generation of a missing portion (hereinafter, appropriately referred to as “defect”) of a digital image signal due to a pixel that does not function normally is seen as a problem. When pixel defects more than a regulation are recognized in a defect inspection at the time of manufacturing the camera module, the camera module is treated as a defective product. As the regulation becomes strict, the yield of the camera module is reduced and thus the manufacturing cost is increased.

Conventionally, a method of making the defect less noticeable by signal processing in a defect correcting circuit is positively employed. Moreover, as the increase in the number of pixels of the camera module progresses, high performance is required for a scaler circuit for resizing or electronic zooming of an image in accordance with the number of pixels of a display.

The scaler circuit calculates a new signal value by a convolution operation in which signal values of a plurality of peripheral pixels are used in scaling processing of generating a low-resolution image from a high-resolution image. When the defect exists in the peripheral pixels, the effect of the defect remains as a noise also in the low-resolution image after the scaling processing. Therefore, when the defect correcting circuit and the scaler circuit are combined, it is desired that an image signal subjected to the defect correction in the defect correcting circuit be input to the scaler circuit. Moreover, in a conventionally-proposed defect correcting method, the signal value after the defect correction is obtained by using the signal values of the peripheral pixels, so that a line memory is necessary as a component of the defect correcting circuit. In the configuration in which the defect correcting circuit and the scaler circuit are both provided, the line memory for the pixel size in the horizontal direction is provided for each circuit. Specially, the circuit size increases significantly as the pixel size of the camera module becomes large. Moreover, when crop processing is performed for the electronic zooming, a portion other than the target for the crop processing also becomes the target for the defect correction, so that power is consumed for unnecessary defect correction.

### BRIEF DESCRIPTION OF THE DRAWINGS

FIG. 1 is a block diagram illustrating a configuration of a camera module including an image processing apparatus according to a first embodiment;

FIG. 2 is a block diagram illustrating a configuration of a scaler circuit with a defect correction function;

FIG. 3 is a diagram explaining an example of an embodiment of defect correction and scaling processing by the scaler circuit with the defect correction function;

FIG. 4 is a diagram illustrating a specific circuit configuration example of a convolution operation circuit;

FIG. 5 is a block diagram explaining an operation of the scaler circuit with the defect correction function;

FIG. 6 is a diagram explaining a relationship between the defect correction by the scaler circuit with the defect correction function and crop processing;

FIG. 7 is a block diagram explaining an operation of the scaler circuit with the defect correction function in an image processing apparatus according to a second embodiment; and

FIG. 8 is a diagram explaining an example of an embodiment of the defect correction and the scaling processing by an image processing apparatus according to a third embodiment.

### DETAILED DESCRIPTION

In general, according to one embodiment, an image processing apparatus includes a weight coefficient calculating unit, a defect-correction-coefficient switching unit, and a convolution operation unit. The weight coefficient calculating unit calculates a weight coefficient for scaling processing with respect to input pixels whose signal values are input as image data. The defect-correction-coefficient switching unit performs switching of the weight coefficient for defect correction for a defect correction target pixel in which a defect is detected from among the input pixels. The convolution operation unit performs a convolution operation in which a weight coefficient group including the weight coefficient that is subjected to the switching by the defect-correction-coefficient switching unit is used.

Exemplary embodiments of an image processing apparatus, an image processing method, and a camera module will be explained below in detail with reference to the accompanying drawings. The present invention is not limited to the following embodiments.

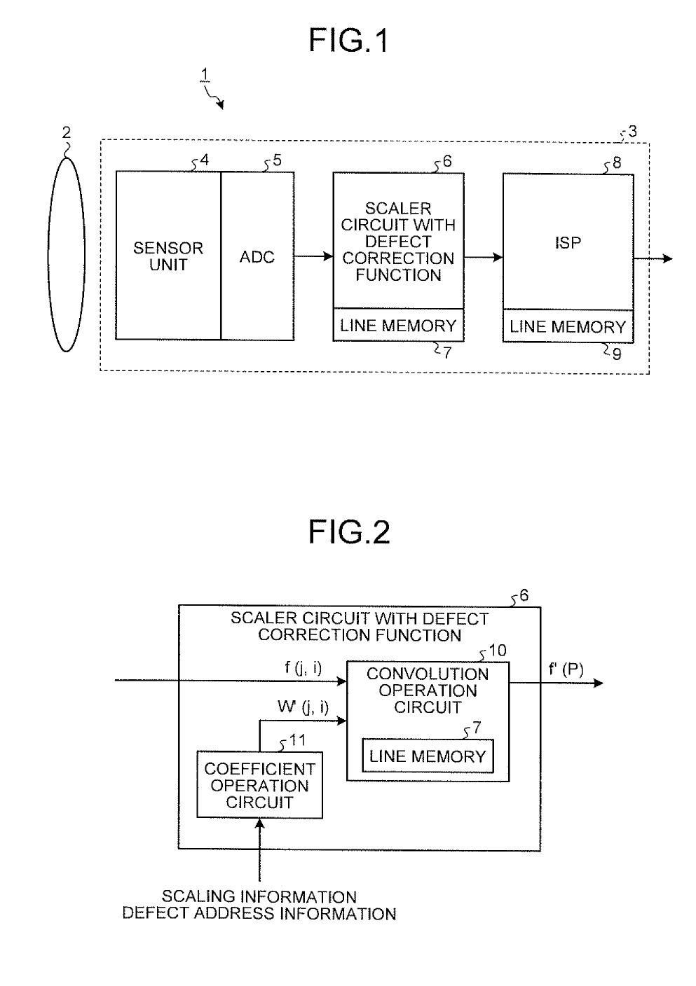

FIG. 1 is a block diagram illustrating a configuration of a camera module 1 including an image processing apparatus 3 according to a first embodiment. The camera module 1 includes an imaging lens 2 that captures light from an object and the image processing apparatus 3.

The image processing apparatus 3 includes a sensor unit 4, an analog-digital converter (ADC) 5, a scaler circuit 6 with a defect correction function, and an image signal processor (ISP) 8. The sensor unit 4 images an object image by converting light from an object into signal charges. The sensor unit 4 captures signal values of R, G, and B in the order corresponding to the Bayer array, and sequentially amplifies and outputs the captured analog image signals with a gain corresponding to the imaging condition specified from the outside. The ADC 5 converts the analog image signal output from the sensor unit 4 into a digital image signal.

The scaler circuit 6 with the defect correction function performs a defect correction and scaling processing. The ISP 8 performs various image processing, such as demosaicing, a white balance adjustment, and gamma processing, on the digital image signal output from the scaler circuit 6 with the defect correction function. The scaler circuit 6 with the defect correction function and the ISP 8 include line memories (delay elements) 7 and 9, respectively.

FIG. 2 is a block diagram illustrating the configuration of the scaler circuit 6 with the defect correction function. The scaler circuit 6 with the defect correction function includes a convolution operation circuit (convolution operation unit) 10 and a coefficient operation circuit 11. The coefficient operation circuit 11 calculates a weight coefficient in accordance with scaling information and defect address information. The convolution operation circuit 10 performs a convolution operation in which the weight coefficient calculated in the coefficient operation circuit 11 is used. The scaling information is information representing a scale rate by scaling setting. The defect address information is information representing a position of a defect detected by a defect detecting unit.

In the present embodiment, the defect address information can be any of information prestored in a memory by defect detection in a defect inspection and information detected in real time from the digital image signal during operation of the camera module 1. The scaling processing can be performed by any algorithm. As the algorithm, for example, a bi-cubic method, a bi-linear method, a nearest neighbor method, or the like, or an algorithm derived therefrom is used. The algorithm is appropriately selected in accordance with the level of performance required for the specification of the camera module 1 or the circuit size.

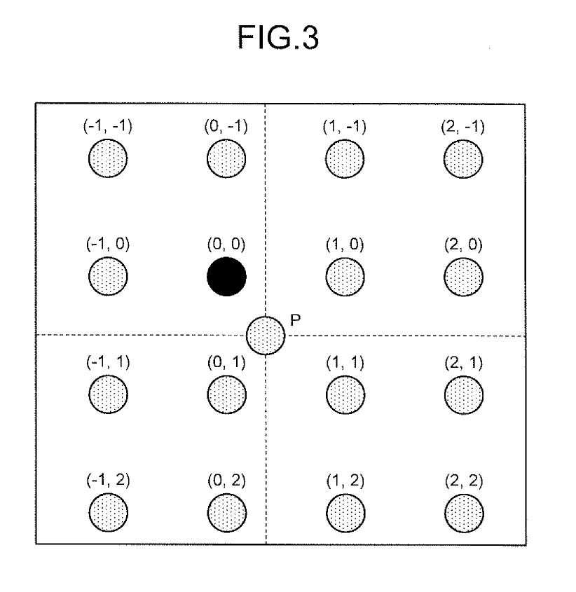

FIG. 3 is a diagram explaining an example of an embodiment of the defect correction and the scaling processing by the scaler circuit 6 with the defect correction function. (j,i) represents coordinates of a pixel used in the convolution operation for generating one pixel by the scaling processing from among input pixels of the same color whose signal values are input as image data from the ADC 5. In this example, the scaling processing by the scaler circuit 6 with the defect correction function is downscaling of generating one pixel P from 16 input pixels constituting a matrix of four (j=−1,0,1,2) pixels in a horizontal direction and four (i=−1,0,1,2) pixels in a vertical direction. f(j,i) shown in FIG. 2 is the signal value of a pixel positioned at (j,i). W′(j,i) is the weight coefficient calculated in the coefficient operation circuit 11 for a pixel positioned at (j,i). f′(P) is the signal value of the pixel P calculated in the scaler circuit 6 with the defect correction function.

The defect as a target for the defect correction by the scaler circuit 6 with the defect correction function includes a so-called black defect in which a luminance becomes lower than the case where a pixel functions normally and a so-called white defect in which the luminance becomes higher than the case where a pixel functions normally. The case is explained as an example, in which the black defect occurs in a pixel (0,0). When the scaling processing is performed in a state of including the black defect, a noise in which the output luminance of the pixel P becomes lower than normal occurs. In the followings, the pixel (0,0) as a target of the defect correction is appropriately called a “defect correction target pixel”, and 15 pixels other than the defect correction target pixel among 16 input pixels are appropriately called peripheral pixels. In each embodiment, the case is explained as an example in which the target of the defect correction is the black defect; however, it is similar in the case of the white defect. When the scaling processing is performed in a state of including the white defect, a noise in which the output luminance of the pixel P becomes higher than normal occurs.

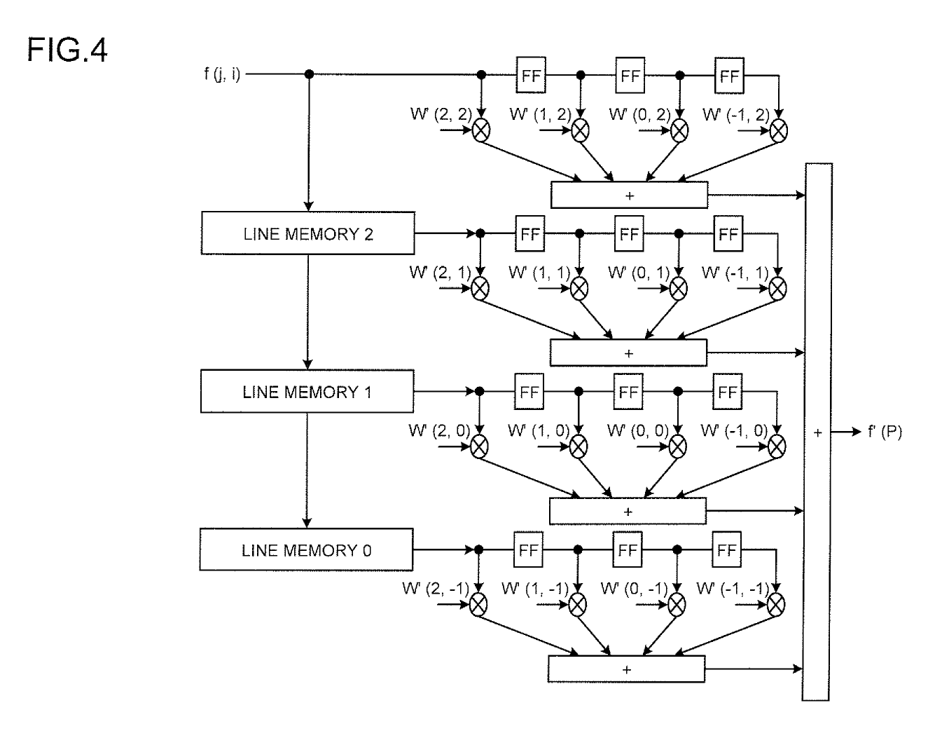

FIG. 4 is a diagram illustrating a specific circuit configuration example of the convolution operation circuit 10. The line memory 7 shown in FIG. 2 includes three line memories 0, 1, and 2, and holds the digital image signals for three lines. Each of the line memories 0, 1, and 2 temporarily stores therein the signal values for one line in the horizontal direction of the input image. The convolution operation circuit 10 includes three line memories 0, 1, and 2 and a four-stage FIR filter. The FIR filter includes FF (FlipFlop) circuits that each temporarily store therein the signal value of the input pixel, multipliers that each multiply the signal value by the weight coefficient W′(j,i), and adders that each add the signal values multiplied by the weight coefficients W′(j,i). The convolution operation circuit 10 is not limited to the configuration explained in the present embodiment. For example, the number of the lines of the line memory or the number of the stages of the FIR filter can be appropriately changed in accordance with the number of the lines required in the scaling processing.

The signal value f′(P) of the pixel P is a value obtained by multiplying the respective signal values of 16 input pixels for four lines, i.e., three lines held in the line memories 0, 1, and 2 and the input one line by the weight coefficients W′(j,i) and adding them. The signal value f′(P) is represented by the following equation.

$${f}^{′} ( P ) = {\sum }_{i = - 1}^{2} {\sum }_{j = - 1}^{2} {W}^{′} ( j , i ) f ( j , i ) \qquad ( 1 )$$

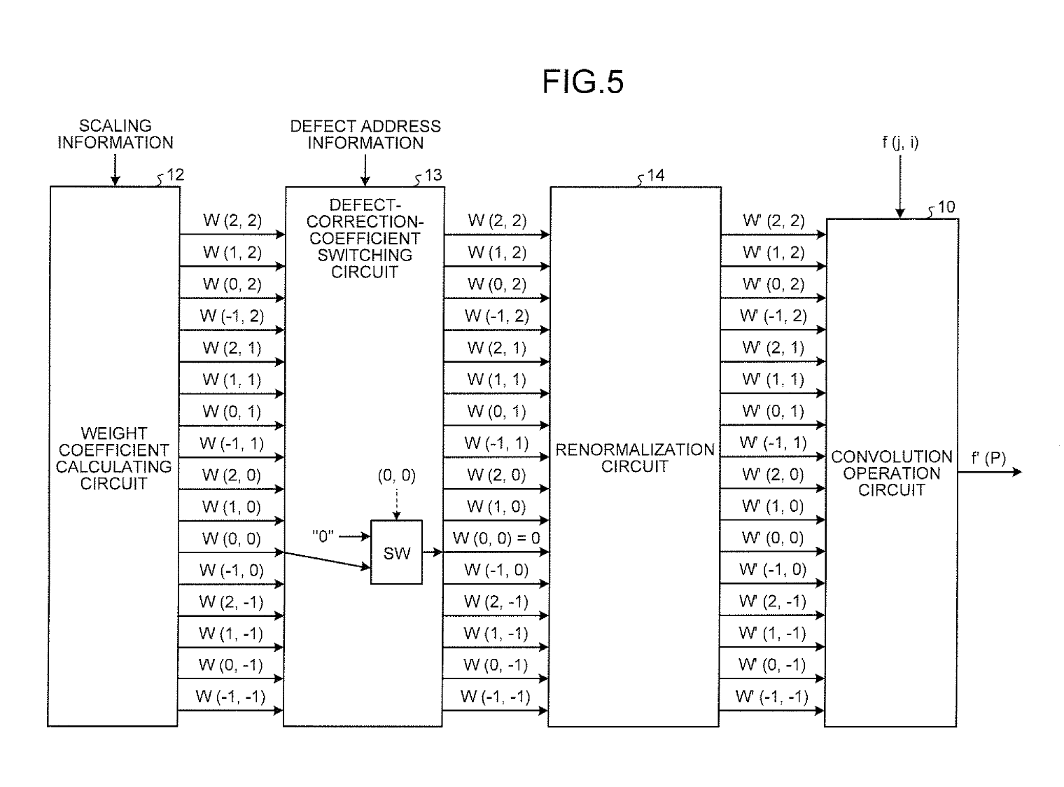

FIG. 5 is a block diagram explaining an operation of the scaler circuit 6 with the defect correction function. The coefficient operation circuit 11 shown in FIG. 2 includes a weight coefficient calculating circuit (weight coefficient calculating unit) 12, a defect-correction-coefficient switching circuit (defect-correction-coefficient switching unit) 13, a renormalization circuit (renormalization circuit) 14. The weight coefficient calculating circuit 12 calculates the weight coefficient W(j,i) for the scaling processing in accordance with the scaling information. The weight coefficient W(j,i) is calculated based on the distance from the pixel P.

The defect-correction-coefficient switching circuit 13 performs switching of the weight coefficient for the defect correction for the defect correction target pixel. A switch SW of the defect-correction-coefficient switching circuit 13 switches the weight coefficient W(0,0) with respect to the defect correction target pixel (0,0) to “0” in accordance with the defect address information.

The renormalization circuit 14 performs renormalization processing on a weight coefficient group from the defect-correction-coefficient switching circuit 13. The renormalization processing is operation processing for equalizing the sum of the weight coefficient group before and after the switching by the defect-correction-coefficient switching circuit 13. In the case of this example, the weight coefficient W(0,0) before switching to zero for the defect correction target pixel is distributed to the weight coefficient for each peripheral pixel. The renormalization processing by the renormalization circuit 14 is performed, so that the sum of the output luminance before and after the switching of the weight coefficient for the defect correction can be kept constant. The renormalization circuit 14 outputs the weight coefficient W′(j,i) on which the switching for the defect correction and the renormalization processing are performed.

The convolution operation circuit 10 performs the convolution operation in which the signal values f(j,i) of the input pixels and the weight coefficient group from the renormalization circuit 14 are used and outputs the signal value f′(P) of the pixel P. In this manner, the convolution operation circuit 10 performs the convolution operation in which the weight coefficient group subjected to the switching by the defect-correction-coefficient switching circuit 13 and the renormalization processing by the renormalization circuit 14 is used.

As above, the scaler circuit 6 with the defect correction function performs the scaling processing in the state of including the weight coefficients subjected to the switching for the defect correction, so that the effect of the defect to an image after the scaling processing can be reduced. The image processing apparatus 3 can obtain a high-quality image subjected to the appropriate defect correction and scaling processing. Moreover, the image processing apparatus 3 is configured such that the line memory 7 can be used in common in the defect correction and the scaling processing, so that the circuit size can be reduced significantly compared with the case of providing the line memory for each of the defect correction circuit and the scaler circuit. Specially, increase in circuit size can be effectively suppressed as the pixel size of the camera module 1 becomes large.

The image processing apparatus 3 can perform electronic zooming by combining the scaling processing in the scaler circuit 6 with the defect correction function with crop processing. For example, when converting from 5 megapixel size (2608×1960) into XGA (1024×768), the electronic zooming from 1 to 2.5 times can be realized.

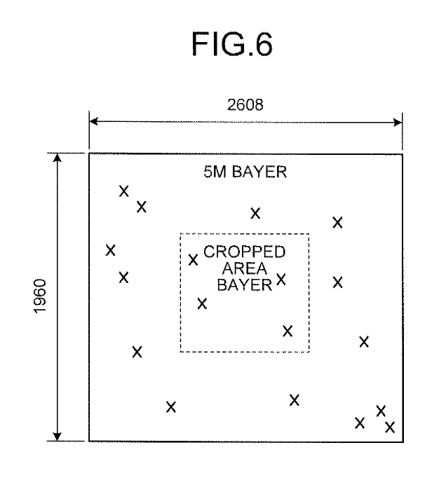

FIG. 6 is a diagram explaining a relationship between the defect correction by the scaler circuit 6 with the defect correction function and the crop processing. For example, it is assumed that the defect occurs at positions marked by “x” in FIG. 6. As explained with reference to FIG. 5, the convolution operation circuit 10 performs the switching of the weight coefficient for the defect correction in the defect-correction-coefficient switching circuit 13 after calculating the weight coefficient for the scaling processing in the weight coefficient calculating circuit 12, so that the defect correction in a portion other than the target for the crop processing can be omitted. Thus, in the image processing apparatus 3, power consumption by unnecessary defect correction can be suppressed and therefore a lower power consumption can be realized. For example, in the case of scaling with a high scaling rate, the scaler circuit 6 with the defect correction function can perform the scaling processing with part of the peripheral pixels thinned. In this case again, the defect correction for a pixel other than the target for the scaling processing can be omitted, whereby a lower power consumption can be realized.

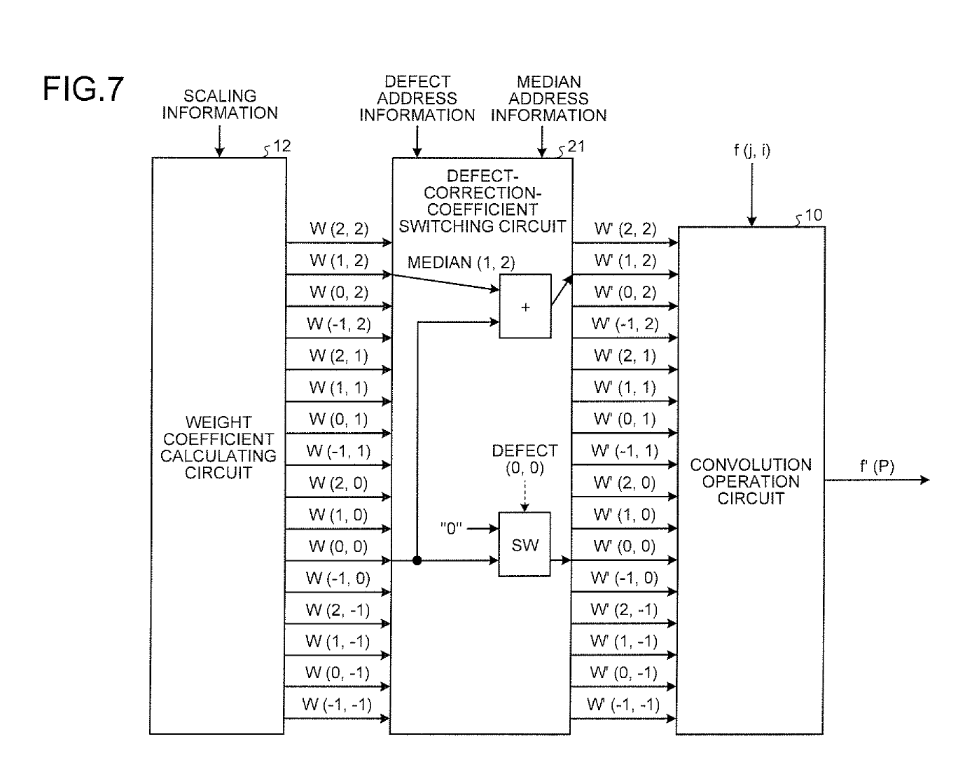

FIG. 7 is a block diagram explaining an operation of the scaler circuit with the defect correction function in an image processing apparatus according to a second embodiment. The present embodiment is characterized in that a defect-correction-coefficient switching circuit (defect-correction-coefficient switching unit) 21 that performs processing equivalent to median filter processing is included. Components that are the same as those in the first embodiment are given the same reference numerals and overlapping explanation is appropriately omitted.

The image processing apparatus according to the present embodiment detects the defect correction target pixel by the defect detecting unit and detects a replacement signal value that is replaced by the signal value of the defect correction target pixel from among the signal values for the peripheral pixels of the defect correction target pixel. In the present embodiment, as the replacement signal value, an intermediate value (median) when the signal values of the peripheral pixels are ordered in terms of the luminance level is employed. For example, when there are 15 peripheral pixels, the eighth largest signal value of the signal values of the peripheral pixels ordered in terms of the luminance level is set as the median. In the followings, a pixel whose signal value is employed as the median among the peripheral pixels is appropriately called “median pixel”. The defect address information and median address information are input to the defect-correction-coefficient switching circuit 21. The median address information is information representing the position of the median pixel.

In an example shown in FIG. 3, a pixel (0,0) is the defect correction target pixel and a pixel (1,2) is the median pixel. The switch SW of the defect-correction-coefficient switching circuit 21 switches the weight coefficient W(0,0) with respect to the defect correction target pixel (0,0) to “0” in accordance with the defect address information. Moreover, the defect-correction-coefficient switching circuit 21 adds the weight coefficient W(0,0) calculated in the weight coefficient calculating circuit 12 for the defect correction target pixel (0,0) to the weight coefficient W(1,2) calculated for the median pixel (1,2).

The adder of the defect-correction-coefficient switching circuit 21 adds the weight coefficients W(0,0) and W(1,2) in accordance with the defect address information and the median address information.

The defect-correction-coefficient switching circuit 21 outputs the weight coefficient W′(j,i) on which switching for the defect correction is performed. The convolution operation circuit 10 performs the convolution operation in which the signal values f(j,i) of the input pixels and the weight coefficient group from the defect-correction-coefficient switching circuit 21 are used and outputs the signal value f′(P) of the pixel P.

In this manner, due to addition of the weight coefficients in the defect-correction-coefficient switching circuit 21, processing equivalent to switching of the signal value of the defect correction target pixel to the median is substantially performed. The image processing apparatus according to the present embodiment enables a circuit size reduction, a lower power consumption, and appropriate scaling processing and can obtain a high-quality image subjected to the defect correction by the processing equivalent to the median filter processing. In the case of the present embodiment, the sum of the output luminance before and after switching of the weight coefficient in the defect-correction-coefficient switching circuit 21 is kept constant, so that the renormalization processing can be omitted.

The replacement signal value is not limited to the case of the median when the signal values of the peripheral pixels are ordered in terms of the luminance level. For example, as the replacement signal value, it is possible to employ the maximum value of the signal values of the peripheral pixels when the defect correction target pixel is the white defect, the minimum value of the signal values of the peripheral pixels when the defect correction target pixel is the black defect, or the like, and various methods of replacing the signal value with respect to a defect pixel can be appropriately applied.

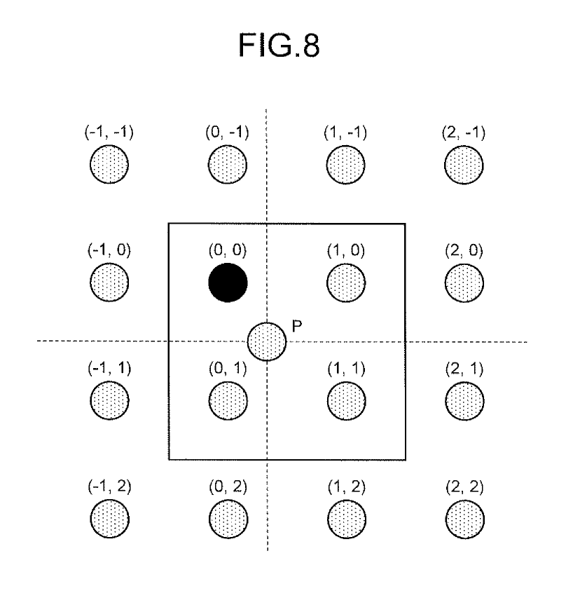

FIG. 8 is a diagram explaining an example of an embodiment of the defect correction and the scaling processing by an image processing apparatus according to a third embodiment. The present embodiment is characterized in that the range of the peripheral pixels for detecting the replacement signal value can be set wider than the range (kernel size) of the input pixels used in the convolution operation for generating one pixel by the scaling processing. Explanation overlapping with the first and second embodiments is omitted. In the second embodiment, the range of the peripheral pixels matches the kernel size.

The kernel size in the present embodiment is four pixels constituting a matrix of two pixels (j=0,1) in the horizontal direction and two pixels (i=0,1) in the vertical direction as indicated by being enclosed by a heavy line in FIG. 8. On the other hand, the range of the peripheral pixels for detecting the replacement signal value is 15 pixels around the defect correction target pixel in the similar manner to the case of the second embodiment. In the case of the present embodiment, the convolution operation circuit 10 shown in FIG. 4 is used, and adjustment of the kernel size is performed with a maximum of 16 pixels of 4×4. When the kernel size is four pixels of 2×2, the weight coefficient W′(j,i) is fixed to “0” for 12 pixels outside the kernel size among 16 pixels to perform the scaling processing.

When the scale rate set by the scaling setting is low, if the replacement signal value is detected in the narrow range used in the convolution operation, it becomes difficult in some cases to employ the signal value appropriate for the defect correction as the replacement signal value depending on the distribution of the signal values. Thus, even when the scale rate is low, the range of the peripheral pixels for detecting the replacement signal value is made wider than the kernel size, so that detection of the replacement signal value appropriate for the defect correction is made possible, thereby enabling to perform effective defect correction and the scaling processing.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising:
a weight coefficient calculating unit that calculates a weight coefficient for scaling processing with respect to input pixels whose signal values are input as image data;
a defect-correction-coefficient switching unit that performs switching of the weight coefficient for defect correction for a defect correction target pixel in which a defect is detected from among the input pixels; and
a convolution operation unit that performs a convolution operation in which a weight coefficient group including the weight coefficient that is subjected to the switching by the defect-correction-coefficient switching unit is used.

2. The image processing apparatus according to claim 1, wherein the defect-correction-coefficient switching unit switches the weight coefficient to zero for the defect correction target pixel.

3. The image processing apparatus according to claim 1, further comprising a renormalization unit that performs renormalization processing for equalizing a sum of the weight coefficient group before and after the switching by the defect-correction-coefficient switching unit, wherein
the convolution operation unit uses the weight coefficient group that is subjected to the renormalization processing by the renormalization unit in the convolution operation.

4. The image processing apparatus according to claim 1, wherein
a replacement signal value that is replaced by a signal value of the defect correction target pixel is detected from among signal values of peripheral pixels of the defect correction target pixel, and
the defect-correction-coefficient switching unit adds the weight coefficient calculated for the defect correction target pixel in the weight coefficient calculating unit to a weight coefficient calculated for a pixel whose signal value is employed as the replacement signal value.

5. The image processing apparatus according to claim 4, wherein the replacement signal value is an intermediate value when the signal values of the peripheral pixels are ordered in terms of a luminance level.

6. The image processing apparatus according to claim 4, wherein a range of the peripheral pixels for detecting the replacement signal value is capable of being set to be wider than a range of the input pixels used in the convolution operation for generating one pixel by the scaling processing.

7. The image processing apparatus according to claim 1, further comprising a line memory that is used in common in the scaling processing and the defect correction.

8. The image processing apparatus according to claim 1, wherein the scaling processing is performed with part of peripheral pixels of the defect correction target pixel thinned.

9. An image processing method comprising:
calculating a weight coefficient for scaling processing with respect to input pixels whose signal values are input as image data;
performing switching of the weight coefficient for defect correction for a defect correction target pixel in which a defect is detected from among the input pixels; and
performing a convolution operation in which a weight coefficient group including the weight coefficient that is subjected to the switching for the defect correction is used.

10. The image processing method according to claim 9, further comprising switching the weight coefficient to zero for the defect correction target pixel.

11. The image processing method according to claim 9, further comprising:
performing renormalization processing for equalizing a sum of the weight coefficient group before and after the switching for the defect correction; and
using the weight coefficient group that is subjected to the renormalization processing in the convolution operation.

12. The image processing method according to claim 9, further comprising:
detecting a replacement signal value that is replaced by a signal value of the defect correction target pixel from among signal values of peripheral pixels of the defect correction target pixel; and
adding the weight coefficient calculated for the defect correction target pixel for the scaling processing to a weight coefficient calculated for a pixel whose signal value is employed as the replacement signal value.

13. The image processing method according to claim 12, wherein the replacement signal value is an intermediate value when the signal values of the peripheral pixels are ordered in terms of a luminance level.

14. The image processing method according to claim 12, wherein a range of the peripheral pixels for detecting the replacement signal value is capable of being set to be wider than a range of the input pixels used in the convolution operation for generating one pixel by the scaling processing.

15. A camera module comprising:
a weight coefficient calculating unit that calculates a weight coefficient for scaling processing with respect to input pixels whose signal values are input as image data;
a defect-correction-coefficient switching unit that performs switching of the weight coefficient for defect correction for a defect correction target pixel in which a defect is detected from among the input pixels; and
a convolution operation unit that performs a convolution operation in which a weight coefficient group including the weight coefficient that is subjected to the switching by the defect-correction-coefficient switching unit is used.

16. The camera module according to claim 15, wherein the defect-correction-coefficient switching unit switches the weight coefficient to zero for the defect correction target pixel.

17. The camera module according to claim 15, further comprising a renormalization unit that performs renormalization processing for equalizing a sum of the weight coefficient group before and after the switching by the defect-correction-coefficient switching unit, wherein
the convolution operation unit uses the weight coefficient group that is subjected to the renormalization processing by the renormalization unit in the convolution operation.

18. The camera module according to claim 15, wherein
a replacement signal value that is replaced by a signal value of the defect correction target pixel is detected from among signal values of peripheral pixels of the defect correction target pixel, and
the defect-correction-coefficient switching unit adds the weight coefficient calculated for the defect correction target pixel in the weight coefficient calculating unit to a weight coefficient calculated for a pixel whose signal value is employed as the replacement signal value.

19. The camera module according to claim 18, wherein the replacement signal value is an intermediate value when the signal values of the peripheral pixels are ordered in terms of a luminance level.

20. The camera module according to claim 18, wherein a range of the peripheral pixels for detecting the replacement signal value is capable of being set to be wider than a range of the input pixels used in the convolution operation for generating one pixel by the scaling processing.
